(19) United States
(12) Patent Application Publication
(10) Pub. No.: US 2006/0248009 A1
(43) Pub. Date: Nov. 2, 2006

(54) System and method for processing electronic payments

(76) Inventors: Sydney Smith Hicks, Dallas, TX (US); Ronald V. Hennel, Frisco, TX (US); Matthew P. Brennan, Dallas, TX (US); Andrew M. Rumpler, Euless, TX (US)

Correspondence Address: FISH & RICHARDSON P.C., P.O. BOX 1022, MINNEAPOLIS, MN, 55440-1022, US

(21) Appl. No.: 11/120,267

(22) Filed: May 2, 2005

(51) Int. Cl. G06Q 40/00

(52) U.S. Cl. 705/40

(57) ABSTRACT

A payments gateway operable to receive a payments file from an originating entity. The payments gateway then invokes a policy associated with the originating entity, with the policy comprising references to at least a subset of a plurality of receiving entities. The payments file is parsed into a plurality of payment records, with each record associated with a particular one of the plurality of receiving entities. The payments gateway identifies a first receiving entity associated with one of the payment records and referenced in the policy and automatically provides a dashboard view to the identified receiving entity with the dashboard view presenting information on the one or more associated payment records.

### TECHNICAL FIELD

This invention relates to check processing and, more specifically, to a system and method for processing electronic payments.

### BACKGROUND

Currently, an originating entity may generate an electronic payment and communicate the electronic payments to a recipient bank (or other financial institution) for deposit or forwarding to the appropriate account holder. In certain situations, the originating entity is a store that must first communicate the checks to its corporate headquarters. The corporate headquarters waits for the checks from all of the related stores, creates a manual deposit slip, and sends the checks to the bank. In the case of physical checks, the checks are typically gathered together and mailed to the appropriate vendors or other receiving entities. Once the receiving entity possesses these checks, they are physically totaled and shipped to the bank of first deposit. These physical deposits are often limited to two hundred fifty checks per deposit and are associated with fees or charges for encoding, bank processing, inter-bank transfers, and/or cash letter charges. Alternatively, each store may deposit items in the nearest local bank, which becomes the bank of first deposit. In this case, the corporate headquarters may be associated with several depository accounts to support their deposit collection process.

The bank of first deposit receives the physical check from the point-of-sale with the physical check including a Magnetic Ink Character Recognition (MICR) code. The bank processes these checks using any suitable technique and communicates the physical check to the recipient (or payor) bank for storage or forwarding to the appropriate account holder. For example, the checks are typically sorted according to payor bank, bundled together, and physically shipped to the receiving bank. This physical handling of checks and other commercial paper transactions requires large amounts of labor, costs, and storage space and is subject to various threats. But the Check Clearing for the 21st Century Act, commonly referred to as “Check 21,” provides a framework for recipient banks to accept electronic images of checks from other banks and their customers, thereby reducing costs and physical threats and increasing efficiency. Each electronic image may then be printed to generate an image replacement document, which is the legal equivalent of a physical check.

### SUMMARY

This disclosure provides a system and method for processing electronic payments. In one embodiment, for example, a payments gateway is operable to receive payments file from an originating entity. The payments gateway then invokes a policy associated with the originating entity, with the policy comprising references to at least a subset of a plurality of receiving entities. The payments file is parsed into a plurality of payment records, with each record associated with a particular one of the plurality of receiving entities. The payments gateway identifies a first receiving entity associated with one of the payment records and referenced in the policy and automatically provides a dashboard view to the identified receiving entity with the dashboard view presenting information on the one or more associated payment records.

In another embodiment, a method for processing electronic payments at a corporate headquarters, comprises receiving a payments file from a store associated with the corporate headquarters, with the payments file including a plurality of electronic payments to at least one receiving entity. A first dashboard view is generated for the store, with the dashboard view presenting a plurality of transmission metrics, and a second dashboard view is generated for a first of the one or more receiving entities, with the second dashboard view providing a plurality of electronic payment information and operable to allow drill downs on the information. The method further comprises generating an Enterprise Resource Planning (ERP) receivables file based on the payments file and the first receiving entity. The ERP receivables file is communicated to the first receiving entity and the payments file is communicated to a financial institution for payment processing.

The details of one or more embodiments of the invention are set forth in the accompanying drawings and the description below. One or more embodiments of the invention may include several important technical advantages. For example, the disclosed techniques may allow a receiving entity (such as a vendor or payee) to view payment details normally hidden during back office processing. Such details may include drill down information including invoices and items that certain payments are associated with. In a further example, the drill down information may be secured from outside viewing or even intra-company or intra-entity viewing (such as between stores or branches). In yet another example, the present disclosure may provide the sending or originating entity with ability to monitor various metrics for transmitting or communicating payments files. In such situations, the originating entity may be further able to establish adaptive thresholds that change with business processes and receive notifications or alerts to management, technical staff, or others of payments outside the thresholds. Of course, various embodiments of the invention may have none, some or all of these advantages. Other features, objects, and advantages of the invention will be apparent from the description and drawings, as well as from the claims.

### DESCRIPTION OF DRAWINGS

FIG. 1 illustrates a system for processing electronic payments in accordance with one embodiment of the present disclosure;

FIG. 2 illustrates an example payments gateway module;

FIGS. 3A-H illustrate various dashboard views of payments file metrics and payment information;

FIGS. 4A-B illustrate one embodiment of an electronic check image in the form of an image replacement document;

FIGS. 5A-B are flowcharts illustrating example methods for processing payments at a payments gateway associated with a financial institution in accordance with certain embodiments of the present disclosure; and

FIG. 6 is a flowchart illustrating an example method for processing payments at a payments gateway associated with a corporate entity in accordance with certain embodiments of the present disclosure.

### DETAILED DESCRIPTION

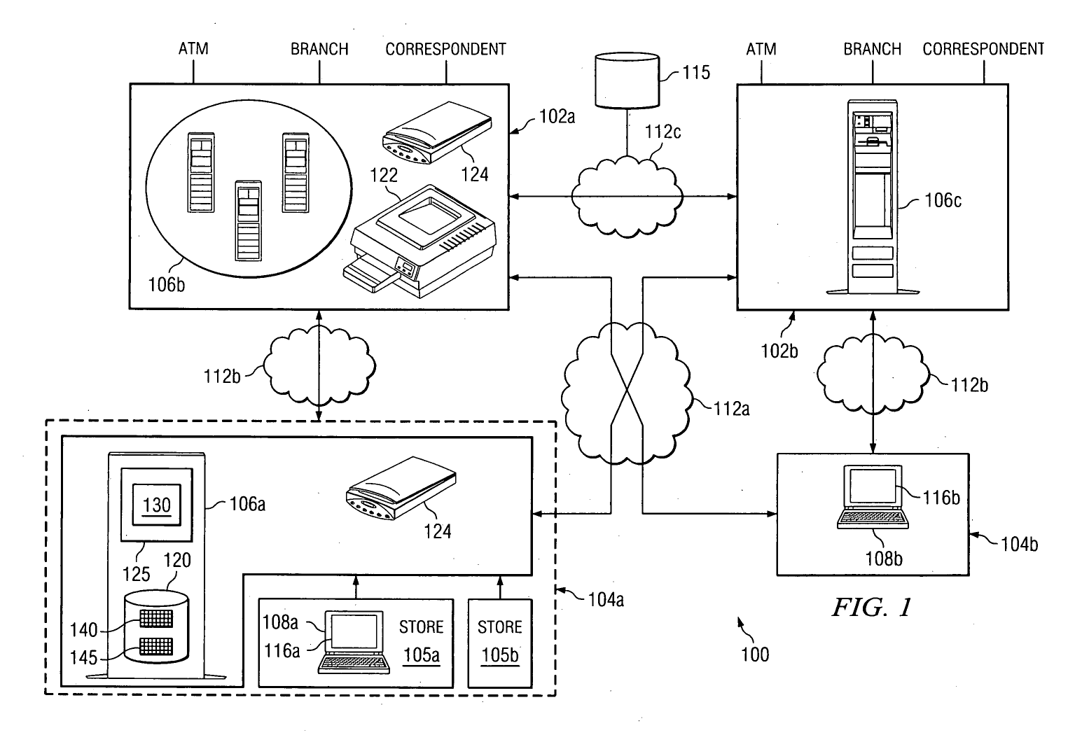

FIG. 1 illustrates a system 100 for processing electronic payments in accordance with one embodiment of the present disclosure. Generally, system 100 includes at least a portion of any retail, financial, or banking system operable to receive and process a payments file from a first entity at a payments gateway 130 resident at a financial institution 102 and/or a corporate entity 104. In certain embodiments, the payments gateway 130 then invokes a policy associated with the sending entity and parses the payments file into a plurality of payment records. Each record is associated with a particular one of a plurality of receiving entities. For example, the payments gateway 130 may receive electronic payments, such as X9.37, Electronic Data Interchange (EDI), or Automated Clearing House (ACH), from a first corporation (the originating entity) to a plurality of other corporations (the receiving entities). The payments gateway 130 identifies a first receiving entity associated with one of the payment records that is referenced in the invoked policy and automatically provides a dashboard view to the identified receiving entity, as well as the originating entity in many circumstances. The dashboard view presenting information on one or more associated payment records, thereby often allowing the payees quick access to back office processing. In other words, the receiving entities can easily view details on expected payments through the dashboard in many embodiments. The term “automatically,” as used herein, generally means that the appropriate processing is substantially performed by at least part of system 100. It should be understood that “automatically” further contemplates any suitable user or manager interaction with system 100 without departing from the scope of this disclosure.

In the illustrated embodiment, system 100 is distributed into two corporate entities 104 (illustrated as first and second corporate entities 104a and 104b) and two financial institutions 102 (first and second financial institutions 102a and 102b). Often, system 100 is electronically inter-coupled, thereby allowing efficient communications among the various components. But system 100 may merely comprise one corporate entity 104 with a plurality of stores, one financial institution 102 with a plurality of interconnected offices or branches, or any other suitable financial environment.

Generally, financial institution 102 is any agent, third-party resource, clearing house, branch, processing center, or central office of a bank or other similar entity. Indeed, while illustrated as two financial institutions 102a and 104b, any number of banks and/or other institutions may be included in system 100 without departing from the scope of this disclosure. Each illustrated financial institution includes an ATM, a branch, and a correspondent, but this is for example purposes only. Moreover, two or more financial institutions 102 may represent two or more routing/transit numbers associated with one banking institution. In other words, each financial institution 102 may have the same, similar, or distinct components from illustrated financial institutions 102. Returning to the illustrated embodiment, each financial institution 102 includes server 106, printer 122, and scanner 124. Printer 122 is any device operable to generate a hard copy from an electronic image. For example, financial institution 102 may possess a plurality of checks or other commercial paper transactions in electronic form, which may then printed as image replacement documents (IRDs) using printer 122. These IRDs may then be considered a legal copy of the associated check. Scanner 124 is any suitable device operable to capture or otherwise obtain information from the received physical transactions, such as the checks from receiving entity 104. For example, scanner 124 may be a scanner, a sorter, a complete image capture system and associated software, or any other similar device (or combination thereof) including a digital camera for recording or generating electronic images of the checks and a MICR reader for capturing MICR data from the checks. The example digital camera may record an electronic check image 114 of the front and back of each check in black and white, grayscale, and/or color. As used herein, electronic check image 114 may be a digital image or file of the check including the front, the back, both, or any suitable portion thereof. This check image 114 may be in any suitable format including Moving Picture Experts Group (MPEG), Joint Photographic Experts Group (JPEG), Tag Image File Format (TIFF), including any suitable version thereof (such as TIFF 6.0), and others. In certain embodiments, electronic check image 114 may be stored in a file that includes a data or image header, a front image in black/white, a front image in grayscale, a back image in black/white, and a back image in grayscale. The MICR reader may capture or generate MICR data, which is a plurality of fields including routing/transit field, account field, serial field, and others separated by spaces and/or dashes.

As illustrated, system 100 also includes one or more corporate entities 104. While generally described as corporations, it will be understood that corporate entity 104 may be any suitable organization, including a corporation, a privately owned store, an online vendor, a telephony system, outside representative or agent, or other original recipient, or location operable to present physical or electronic checks for processing by one of the financial institutions 102. Corporate entity 104 may also be operable to generate an Automated Clearing House (ACH) or EDI transaction based on the checking transaction for quickly processing the transaction with financial institutions 102. In the illustrated embodiment, first corporate entity 104a is communicably coupled with two stores, 105a and 105b respectively. In this embodiment, first corporate entity 104a receives payments from each store for processing by one of the financial institutions 102. For example, first corporate entity 104a may receive physical checks from first store 105a and electronic payments from second store 105b. In this example, first corporate entity 104a may generate electronic checks from the physical checks and consolidate the various check images into one or more payment or EDI files.

As illustrated, financial institutions 102 and first corporate entity 104a include server 106. Server 106 includes memory 120 and processor 125 and comprises an electronic computing device operable to receive, transmit, process, and store data associated with system 100 including payment data between various entities. For example, server 106 may be any computer or processing device such as, for example, a blade server, general-purpose personal computer (PC), Macintosh, a mainframe, or any other suitable device. Generally, FIG. 1 provides merely one example of servers or computers that may be used with the disclosure. For example, although first financial institution 102 illustrates a pool of servers 106 that may be used with the disclosure, system 100 can be implemented using individual servers 106, as well as computers other than servers (e.g. second financial institution includes example mainframe 106b). Indeed, first corporate entity 104a, for example, may implement the various disclosed processes using a laptop or other computing platform. In other words, the present disclosure contemplates computers other than general purpose computers as well as computers without conventional operating systems. As used in this document, the term “computer” is intended to encompass a personal computer, workstation, network computer, or any other suitable processing device. As illustrated, server 106 may be adapted to execute any operating system including Linux, UNIX, Windows Server, z/OS, or any other suitable operating system. According to one embodiment, server 106 may also include or be communicably coupled with a web server, a database server, and/or a secure financial server.

Memory 120 may include any memory or database module and may take the form of volatile or non-volatile memory including, without limitation, magnetic media, optical media, random access memory (RAM), read-only memory (ROM), removable media, or any other suitable local or remote memory component. In the illustrated embodiment, memory 120 includes one or more policy tables 140 and history or audit log 145, but memory 120 may include any appropriate data such as account information, administration profiles, MICR codes, one or more hash values, an all-items file, and others.

Policy table 140 includes instructions, rules, parameters, tags, or other variables operable to instruct payments gateway 130 in processing payments files, determining metrics and comparing to adaptive thresholds, and generating the dashboard view. For example, policy table 140 may maintain, store, or otherwise reference profile information on users, profile information on trading partners, profile information on channels, and/or profile information on scheduler actions. In another example, policy table 140 may allow payments gateway 130 to manage its configuration data through the use of profiles. Using policy table 140, payments gateway 130 may support immediate activation of certain profile changes, delayed activation of certain profile changes, the copying of profiles, the deletion of profiles, the backing up of profile data, the restoration of profile data, and the enabling and disabling of profiles. Policy table 130 may further support hierarchical profiles, inheritance of profile information within hierarchical profiles (i.e. profile information can be set at the parent level, the child profiles will inherit the settings, and the child profiles settings override parent settings), and prevent the deletion of profiles that are in use. In certain embodiments, policy table 140 may support or allow a cascaded delete instead of preventing the deletion.

In one embodiment, policy table 140 may be a persistent file included policies downloaded from one of the corporate entities 104, generated from a template, or generated through a website (such as payments gateway 130). For example, memory 120 may store policy table 140 in a relational database, typically including tables defined using SQL statements and interrelated using schemas. In another example, memory 120 may store policy table 140 in one or more comma-separated-values (CSV) files, XML documents, Virtual Storage Access Method (VSAM) files, Btrieve files, text files, encrypted files, object-oriented database data structures, and others. Audit log 145 allows corporate entity 104 to track various information associated with payment processing, including user actions such profile changes, user access, payment transmissions and receipts, cash letter details, capture bundle details, capture item details, capture image details, and such. As with policy table 140, audit log 145 may be in any appropriate format or structure.

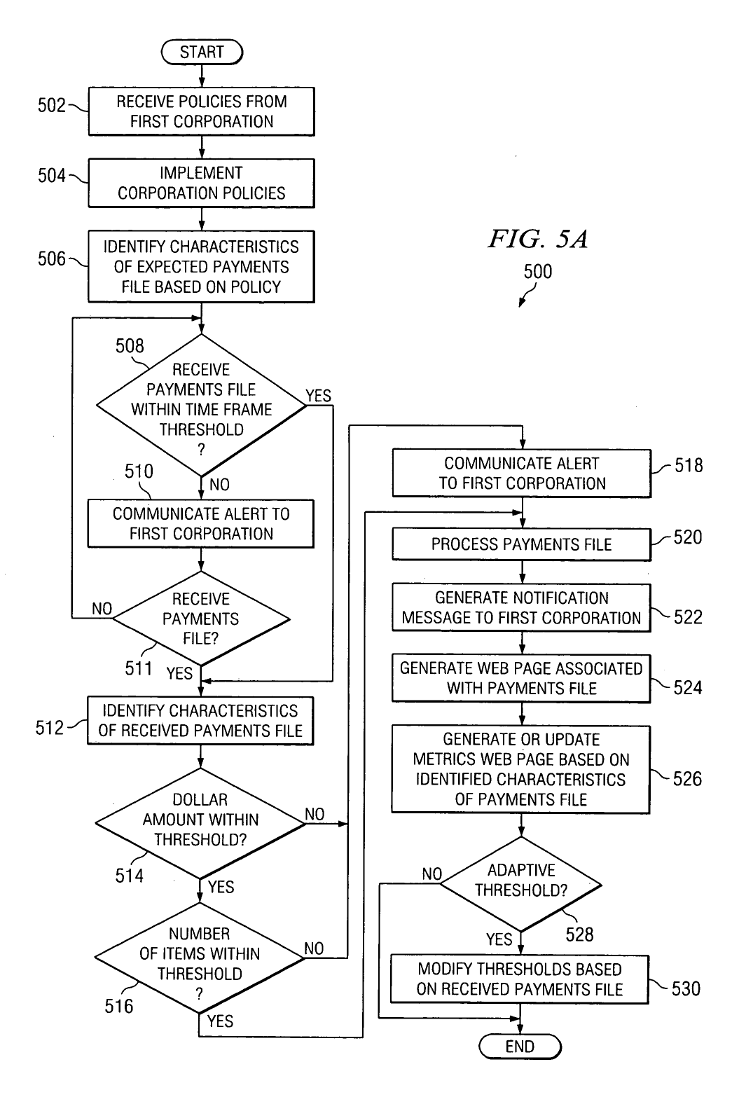

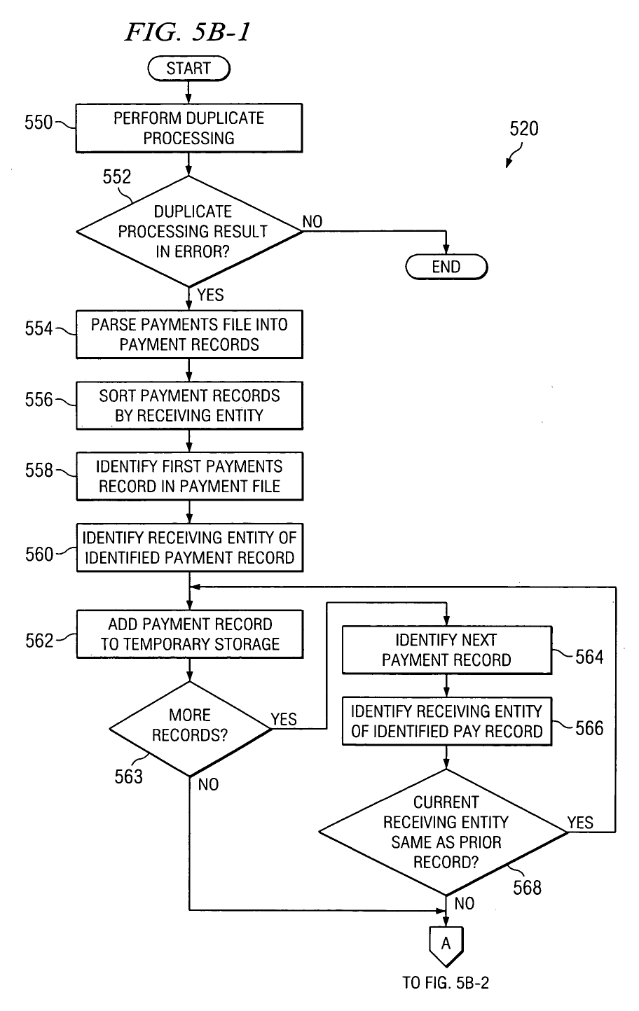

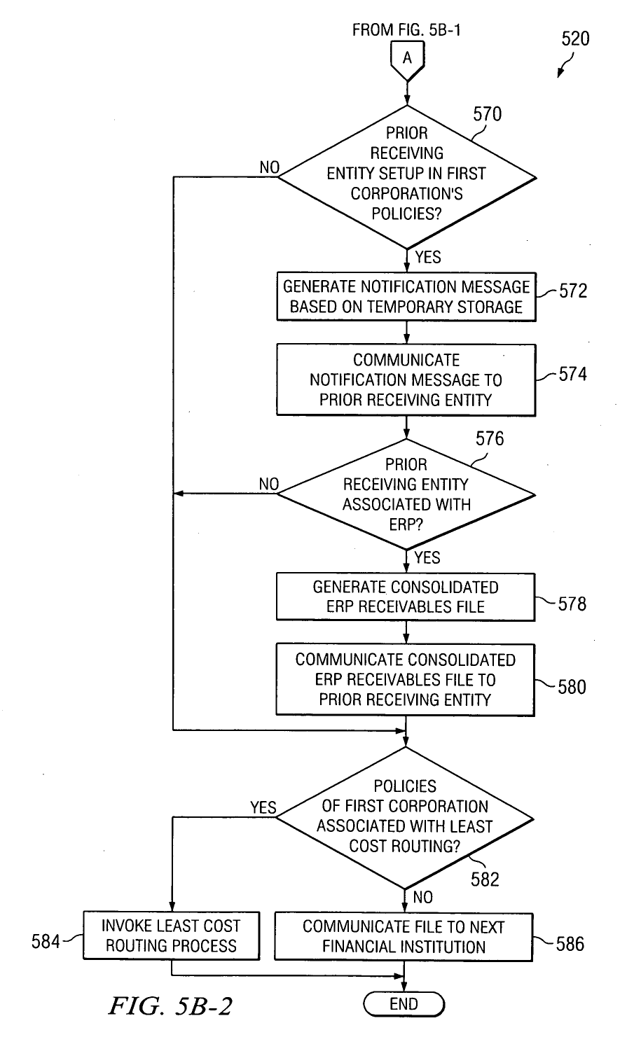

Server 106 also includes processor 125. Processor 125 executes instructions and manipulates data to perform the operations of server 106 such as, for example, a central processing unit (CPU), a blade, an application specific integrated circuit (ASIC), or a field-programmable gate array (FPGA). Although FIG. 1 illustrates a single processor 125 in server 106, multiple processors 125 may be used according to particular needs and reference to processor 125 is meant to include multiple processors 125 where applicable. In the illustrated embodiment, processor 125 executes payments gateway 130, which performs or executes various payment processes such as, for example, techniques described in FIGS. 5A-B and 6.

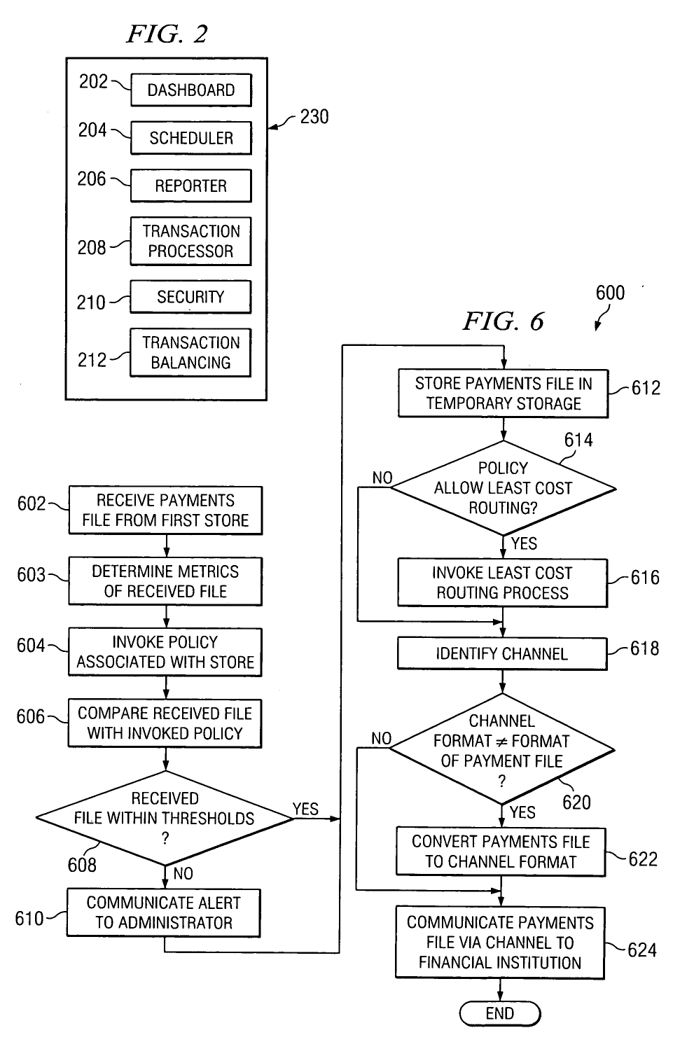

Payments gateway 130 is any module operable to . . . Payments gateway 130 is typically software and may be written or described in any appropriate computer language including, for example, C, C++, Java, J#, Visual Basic, assembler, Perl, any suitable version of 4GL, or any combination thereof. As used herein, software generally includes any appropriate combination of software, firmware, hardware, and/or other logic. It will be understood that while payments gateway 130 is illustrated in FIG. 1 as a single multi-tasked module, the features and functionality performed by this engine may be performed by multiple modules such as, for example, a dashboard generator, a security module, and a payments processor (see FIG. 2). Further, while illustrated as internal to server 106, one or more processes associated with payments gateway 130 may be stored, referenced, accessed, or executed remotely (such through corporate entity 104). For example, such distributed modules may be in communication with one another through XML transactions using Simple Object Access Protocol (SOAP) over Hypertext Transfer Protocol (HTTP) or HTTP over Secure Socket Layer (HTTPS). Put another way, it should be understood that payments gateway 130 may be associated with a particular entity or organization by executing at a corporate or banking headquarters, a bank office or branch, a store, provided by an Application Service Provider (ASP) for the particular one or more entities, as well as many others. Moreover, payments gateway 130 may be a child or sub-module of another software module (not illustrated) without departing from the scope of this disclosure.

In one embodiment, payments gateway 130 may include or be communicably coupled with a graphical user interface (GUI) 116 on an administrative workstation 108 or other remote client. Such clients allow users to logon to payments gateway 130, view the dashboard presentations, view alert or notification messages, and perform many other tasks. In certain embodiments, workstation 108 executes a client view or provides a front-end to an Enterprise Resource Planning (ERP) system or module associated with the particular entity 104. Such ERP modules may reside locally or remotely to workstation 108 and may come in any of variety of versions and from any suitable vendor. Typically, ERP systems are operable to receive incoming interface files, such as receivables files, from external systems, such as payments gateway 130. Returning to the illustration, workstation 108 may comprise a computer that includes an input device, such as a keypad, touch screen, mouse, or other device that can accept information, and an output device that conveys information associated with the operation of server 106 or other corporate entities 104, including digital data, visual information, or GUI 116. Both the input device and output device may include fixed or removable storage media such as a magnetic computer disk, CD-ROM, or other suitable media to both receive input from and provide output to users through the display, namely GUI 116.

GUI 116 comprises a graphical user interface or other dashboard operable to allow the user of the workstation to interface with at least a portion of system 100 for any suitable purpose. Generally, GUI 116 provides the user of any local or remote workstation with an efficient and user-friendly presentation of data provided by or communicated within system 100. GUI 116 may comprise a plurality of customizable frames or views having interactive fields, pull-down lists, and buttons operated by the user. In one embodiment, GUI 116 presents reports that includes the various processed check information and associated buttons and receives commands from the user via one of the input devices. For example, GUI 116 may allow a user to monitor a view into a database, search or query images, view exception reports, and other similar or suitable tasks. More specifically, GUI 116 may present some or all of the following example payment information: incoming volume as the number of incoming items by channel by time period intervals; real-time display of who (which customers and bank employees are initiating real-time displays and reports, as well as analysis of performance impact; real-time output data transfer rates by time interval to the external application; and many others. Indeed, GUI 116 often allows authenticated users to drill down into some or all of the example payment information by date/time range (which may default to 2 hours or may be set by user), geographic region, channel, files, cash letters, bundles, items, images. Further drill downs may include a real-time total volume with drill down by date/time range, geographic region, stores (or capture locations), stores (or capture locations) that have not transmitted as expected, detail within store (files, deposits, items, images), and such.

Moreover, it should be understood that the term graphical user interface may be used in the singular or in the plural to describe one or more graphical user interfaces and each of the displays of a particular graphical user interface. Therefore, GUI 116 contemplates any graphical user interface, such as a generic web browser or touch screen that processes information in system 100 and efficiently presents the results to the user. Server 106 can accept data from workstation 108 via the web browser (e.g., Microsoft Internet Explorer or Netscape Navigator) and return the appropriate HTML or XML responses using network 112.

Server 106 may also include an interface for communicating with other computer systems or components, such as another server 106 or financial institution 102, over network 112 in a client-server or other distributed environment. In certain embodiments, server 106 receives electronic images of checks from internal or external senders through the interface for storage in memory 120 and/or processing by processor 125. Generally, the interface comprises logic encoded in software and/or hardware in a suitable combination and operable to communicate with network 112. More specifically, the interface may comprise software supporting one or more communications protocols associated with communications network 112 or hardware operable to communicate physical signals.

Network 112 facilitates wireless or wireline communication between computer servers 106 and any other local or remote computer or component, such as all or a portion of a bank posting systems or other intermediate systems. For example, network 112a may be a public network such as the Internet. Continuing the example, network 112b may be a dedicated line between corporate entity 104 and illustrated network 112c may be a network internal to corporate entity 104, a virtual private network (VPN), or other local network. But, while illustrated as four networks, 112a, 112b, 112c, and 112d respectively, some or all of network 112 may be a continuous network without departing from the scope of this disclosure, so long as at least portion of network 112 may facilitate communications between the requisite parties or components. In other words, network 112 encompasses any internal or external network, networks, sub-network, or combination thereof operable to facilitate communications between various computing components in system 100. Network 112 may communicate, for example, Internet Protocol (IP) packets, Frame Relay frames, Asynchronous Transfer Mode (ATM) cells, voice, video, data, and other suitable information between network addresses. Network 112 may include one or more local area networks (LANs), radio access networks (RANs), metropolitan area networks (MANs), wide area networks (WANs), all or a portion of the global computer network known as the Internet, and/or any other communication system or systems at one or more locations.

Archive 115 is any intra-bank, inter-bank, regional, or nationwide or substantially national electronic storage facility, data processing center, or archive that allows for one or a plurality of financial institutions 102 (as well as corporate entities 104) to store payments data in its original format or other payment processing data for subsequent access or processing. For example, archive 115 may be a central database communicably coupled with any number of financial institutions 102. In another example, archive 115 may be a tape backup of captured images or payment data. In certain embodiments, archive 115 may be operable to perform one or more of the following processes in response to requests or commands from payments gateway 130: i) store images for each channel based on set parameters with separate parameters for each corporate entity 104; ii) purge image data based on set parameters with separate parameters for each corporate entity 104; iii) retain file for each channel based on set parameters with separate parameters for each corporate customer; iv) purge file data based on set parameters with separate parameters for each corporate entity 104; v) retain item for each channel based on set parameters with separate parameters for each corporate entity 104; and/or vi) purge item data based on set parameters with separate parameters for each corporate entity 104. Regardless, archive 115 may include, store all or part of, or otherwise reference archived data and/or check processing data in any appropriate storage format. For example, archive 115 may warehouse payments data as one or more tables stored in a relational database described in terms of SQL statements or scripts. In another embodiment, the one or more payment records may be stored or defined in various data structures as text files, XML documents, VSAM files, TIFF files, CIM files, flat files, Btrieve files, CSV files, internal variables, or one or more libraries. In short, archive 115 may comprise one table or file or a plurality of tables or files stored on one computer or across a plurality of computers in any appropriate format. Moreover, archive 115 may be physically or logically located at any appropriate location including in one of the financial institutions 102 or off-shore, so long as it remains operable to store archived images and/or other associated payment data associated with a plurality of transactions. In certain embodiments, archive 115 may be a generic or standard repository.

In one aspect of operation, a first store associated with first corporate entity 104a generates one or more payments to a particular vendor or other receiving entity, such as second corporate entity 104b. For some originating entities, the store may communicate these payments to corporate headquarters for consolidation with other stores, scan the physical checks into electronic payments using scanner 124, or perform any other suitable processing. The corporate headquarters (or other data processing center associated with first corporate entity 104) may identify and invoke a policy, which is associated with the store that transmitted the payments, from policy table 140. Payments gateway 130 may parse the invoked policy to identify various thresholds referenced in the policy. Using these thresholds, payments gateway 130 identifies particular metrics of the received payments file that are unexpected, undesired, or otherwise outside an expected range or tolerance. Payments gateway 130 may then generate a web page for viewing by the particular store that is secured from access by the other stores. This web page may include information identifying the payment, its status (received, approved, rejected, etc.), number of items, or any other suitable metric. Payments gateway 130 may also generate a web page for viewing by an administrator at the corporate headquarters or data processing center. Alternatively or in combination, payments gateway 130 may automatically send an alert message to appropriate recipients, often containing dynamic content. This alert message may be an email message, a Short Messaging Service (SMS) message, a fax message, an automated phone message, an EDI formatted message, or other communication in any policy-based messaging format. A single event may trigger separate alert massages to several individuals or entities via different channels. For example, a database administrator may receive an SMS Message or page, a customer may receive an email, and a administrator of the particular payments gateway 130 may receive a system alert that is sent to an internal account that can be viewed within payments gateway 130. Of course, payments gateway 130 may generate one web page and allow access by the administrator of the current facility, as well as the sending store. It will be understood that in the aforementioned example, the particular store may be considered the originating entity.

At any suitable time, the corporate headquarters may send a consolidated payments file to first financial institution 102a for processing through a second payments gateway 130. Of course, while described as second payments gateway 130, if the sending corporate entity 104 does not have the payments gateway 130 installed or running, then payments gateway 130 associated with financial institution 102 may be the only (or first) payments gateway 130. Regardless, the corporate headquarters, the data processing center, or first corporate entity 104a may now be considered the originating entity in terms of example second payments gateway 130. The second payments gateway 130 may have previously invoked all or a part of a policy associated with the sending or originating entity (in this example, the corporate headquarters) from local policies table 140, thereby allowing financial institution 102a to i) monitor expected receipt times; ii) notify sending entity of possible missed files; iii) monitor or poll expected destinations of payments files; and such. Once first financial institution 102a receives the payments file, second payments gateway 130 identifies or measures metrics of the received payment file. For example, the second payments gateway 130 may identify the total number of items, the total dollar amount, as well as many others. Payments gateway 130 then generates a plurality of dashboard views 116 based on the payments file, often using the loaded policy as a guide. For example, a first dashboard view 116 may present a plurality of measured or identified metrics for the received payments file. Certain metrics that violated the associated thresholds may be presented in a distinct format such as a different font, location, or color. The first dashboard view 116 may be accessed by an authenticated user associated with originating entity 104a using HTTPS or other secure technology. Second payments gateway 130 may also generate a second export view for each vendor or payee of the payment records in the payments. For example, the second dashboard view 116 may allow each receiving entity 104b, which is granted access based on the originating entity's policy, to view expected payments, overall metrics of the associated payments, as well as individual payment information such as invoices, items, and many others.

First financial institution 102a may then send the appropriate electronic check images to recipient financial institution 102b for processing. As described above, these electronic check images are each operable to generate an IRD, thereby reducing or eliminating the need for shipping the physical checks. First financial institution 102a may create Electronic Check Presentment (ECP) data files, ECP Image Files (ECPi), Image Cash Letters (non-ECP), IRD Cash Letters, and others as appropriate. These data files are typically formatted in compliance with exchange network specifications, populated with image and IQA records (if desired or suitable), and routed to the appropriate exchange network as specified in the profile. For example, first financial institution 102a may communicate electronic check images to an office local to recipient financial institution 102b. The local office may print a plurality of IRDs from the received electronic images and provide the IRDs to the recipient financial institution 102b. Continuing the example, the local office then forwards the electronic check images to the recipient financial institution 102b at any later time. In another example, server 106a may communicate electronic check images to recipient financial institution 102b via network 113. In this example, the bundled check images may conform to the X9.37 standard. However obtained, recipient financial institution 102b is then operable to generate the IRD. In certain embodiments, second payments gateway 130 may invoke a least cost routing algorithm for the particular sending entity 104 or receiving entities 104b. In these embodiments, payments gateway 130 may automatically determine the more efficient or cost-reducing channels for the payment files.

In another aspect of operation, a store captures images and transmits them to a first payments gateway 130 that is associated with the corporate headquarters of first corporate entity 104a. In this embodiment, first payments gateway 130 implements a least cost routing algorithm that is enabled once corporate headquarters loads the various bank charges for associated clearing services (such as ACH conversion or image deposit). Based on at least some of these charges, first payments gateway 130 calculates the least cost routing for first corporate entity 104a. Moreover, first payments gateway 130 may include or invoke a monitoring portal for both the stores and corporate headquarters.

Corporate headquarters may also send a corporate payables file from their ERP system to a second payments gateway 130 of a first financial institution 102a. Of course, if first corporate entity 104a has more than one ERP system, then several files may flow into second payments gateway 130 and be monitored. In other words, first corporate entity 104a may then view and monitor both the associated payables files and the check image receivables files. In certain embodiments, first corporate entity 104a may decide to delay some payables that they can see via the dashboard views. Throughout the day, first corporate entity 104a may also view, for example, wire payment receivables, ACH receivables, lockbox payment receivables, and/or credit card payments for receivables that can be monitored with drill down capabilities. In this example operation, first financial institution 102a communicates (perhaps at the end of the day) a consolidated receivables file in the ERP format of the Corporate or there may be several consolidated receivables files if the Corporation has more than one ERP system.

Based on the least cost routing process, the payments files are sent to the appropriate financial institutions 102 through their respective payments gateways 130. Each of these payments gateways 130 for the financial institutions 102 may also implement least cost routing algorithms for use with associated clearing institutions. For example, first financial institution 102a may not desire to offer more than one clearing option to their corporate customers 104. In this case, the monitoring provided by payments gateways 130 may be seen by first financial institution 102a alone. In another example, first financial institution 102a may allow a clearing bank, or second financial institution 102b, to access payments gateway 130 so that it can monitor what is coming in advance. This example might allow various processes to begin earlier. Such processing may include, for example, advance detection of fraudulent items, advance collection of information to compare with positive pay files, and others.

FIG. 2 illustrates one embodiment of payments gateway 230. At a high level, this embodiment of payments gateway 230 includes dashboard 202, scheduler 204, reporter 206, transaction processor 208, security engine 210, and transaction balancing module 212. But, of course, these sub-modules are for example purposes only and payments gateway 130 may include none, some, or all of the illustrated sub-modules (as well as others). Moreover, one or more of the sub-modules may be remote, dynamically linked, or invoked as appropriate.

Dashboard 202 is any software process or module operable to monitor incoming files, identify desired metrics, and automatically generate dashboard views. For example, dashboard 202 may monitor incoming volume, which may be the number of incoming items by channel by time period intervals, and allow drill-down from high-level information to more detailed information. Dashboard may also monitor total volume, total dollar amount, as well as numerous other metrics. Moreover, these metrics may include performance indicators such as volumes, number of incoming files, number of incoming cash letters, number of incoming bundles, number of incoming items, number of incoming images, users, number of trading partners, scalability, and/or reliability.

Scheduler 204 may be operable to move input data to output files for processing by other payment applications or modules and may support recurrence for the movement. Often, scheduler 204 supports jobs, which are scheduled tasks, and include job name, description, and task). The set of tasks are normally statically defined as part of the application. Scheduler 204 may also support the definition of an expected event. The set of events are statically defined as part of the application. Moreover, scheduler 204 may allow the administrator or other user to schedule once, periodically, daily, weekly, monthly, and yearly. Reporting module 206 may be any standard or propriety module operable to generate reports, notification messages, and alerts. Transaction processor 208 is typically any software operable to parse payment or image files in nearly any format, perform duplicate processing, and perform other payment processing.

Security engine 210 is any software module operable to help ensure the security of payments gateway 130. For example, security engine 210 may be operable to monitor or secure access and update capabilities. In this example, security engine 210 may authenticate users by requiring them to log in each time they use the application, automatically log out users as soon as they leave the gateway, disconnect sessions when inactive for a certain number of minutes, help prevent simultaneous logins, and/or enabling and disabling of user accounts. Security engine 210 may also protect against cross-site scripting, as well as require or utilize SSL for certain sensitive pages traveling on the public Internet. Security engine 210 may be further operable to control access to archive 115 data, control access of profile data, and/or validate the source of a file. Transaction balancing module 212 may be operable to ensure that incoming files balance. For example, transaction balancing module 212 may process X9.37 payments to determine if the included items match the expected total dollar amount.

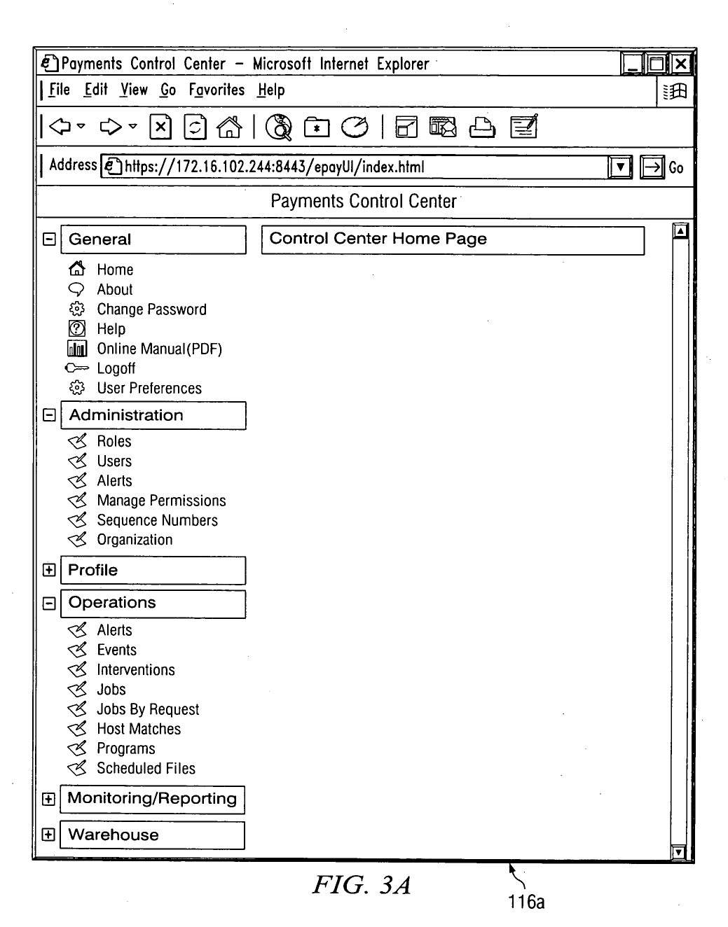

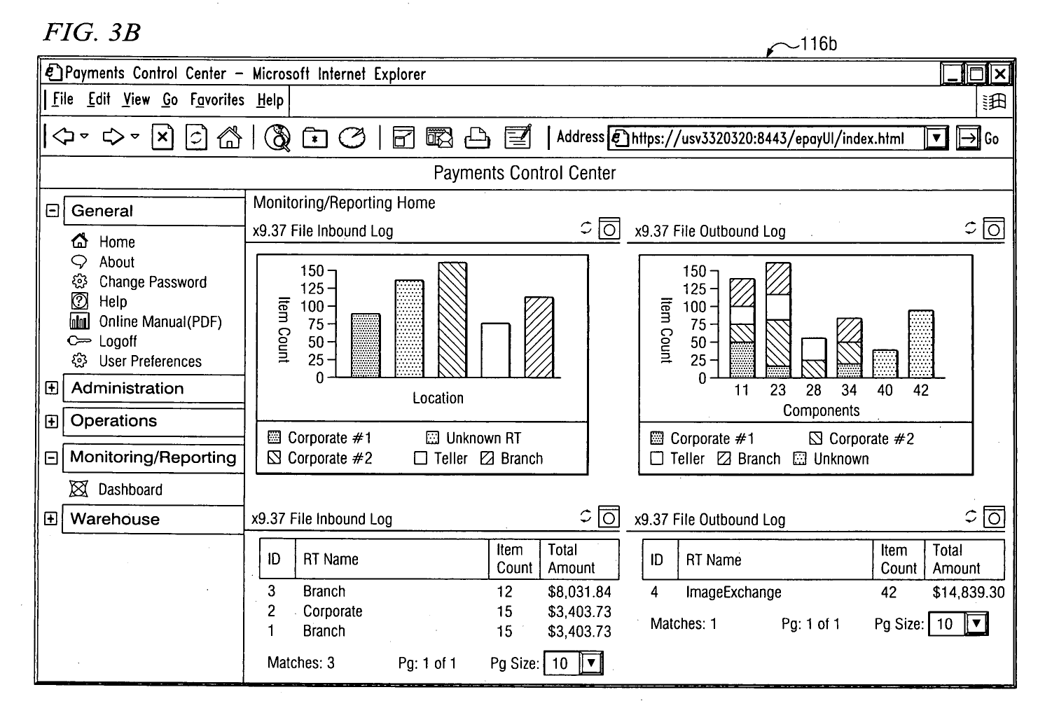

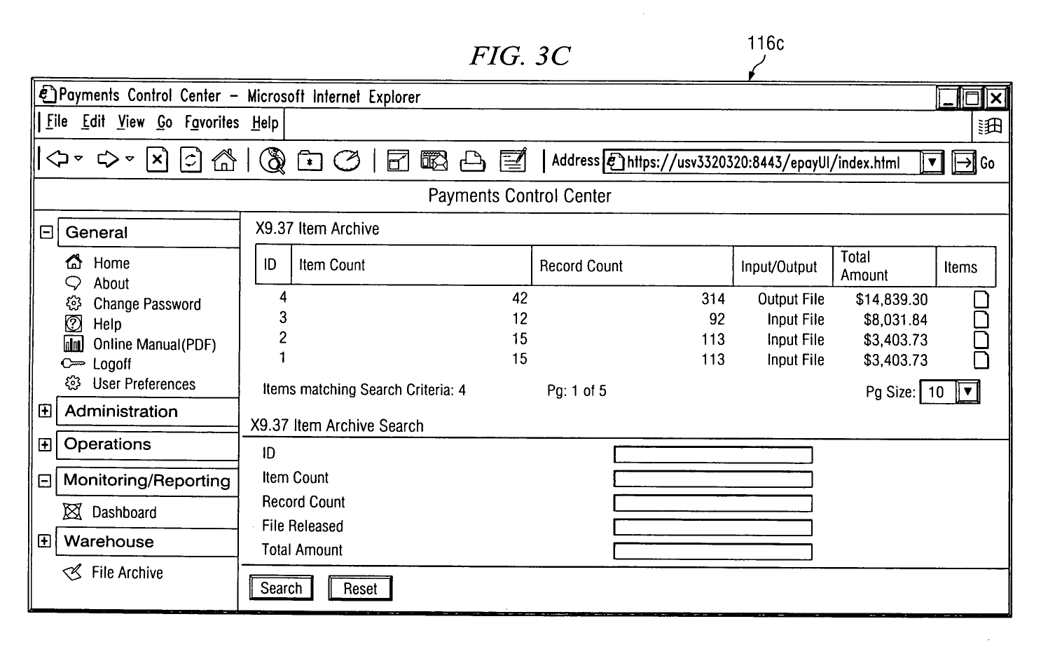

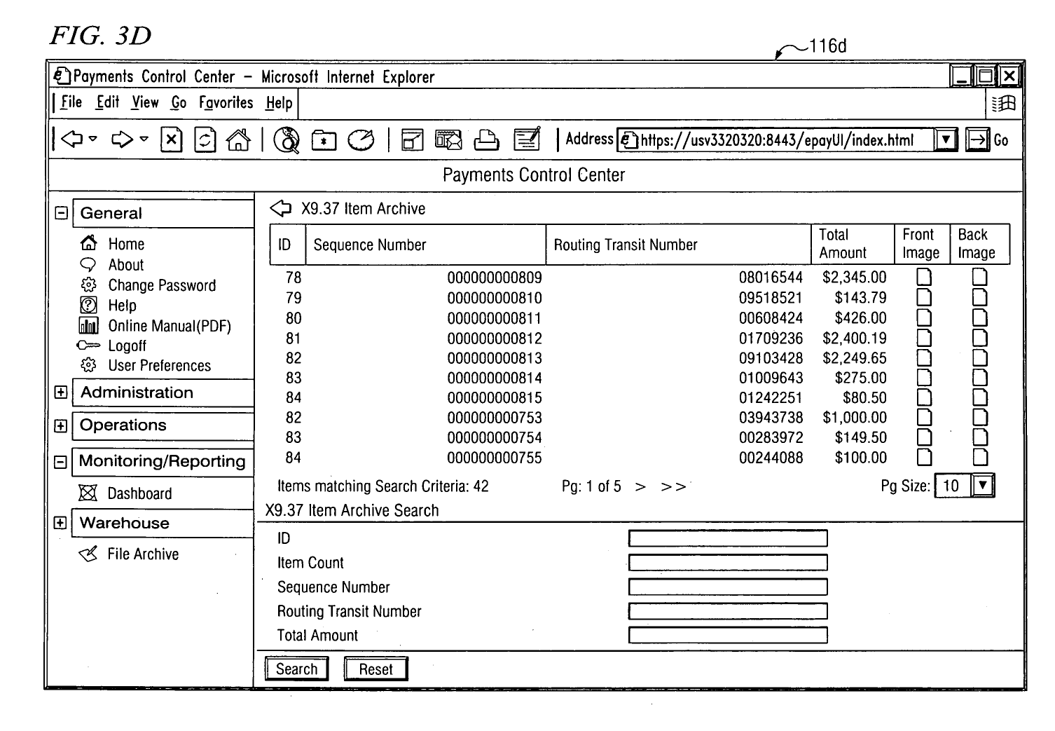

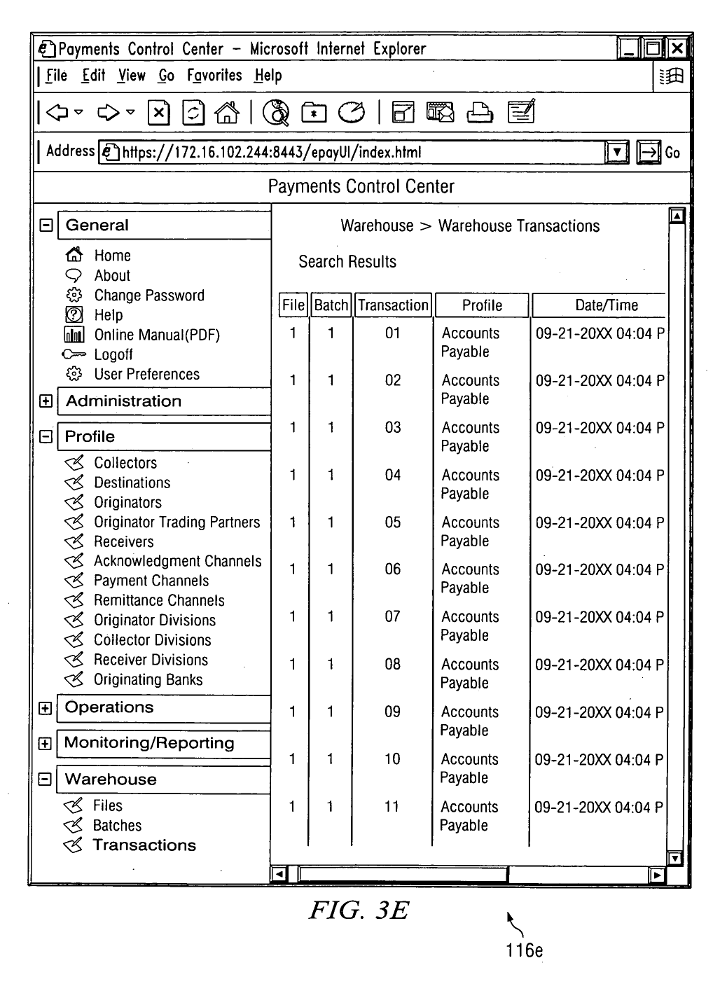

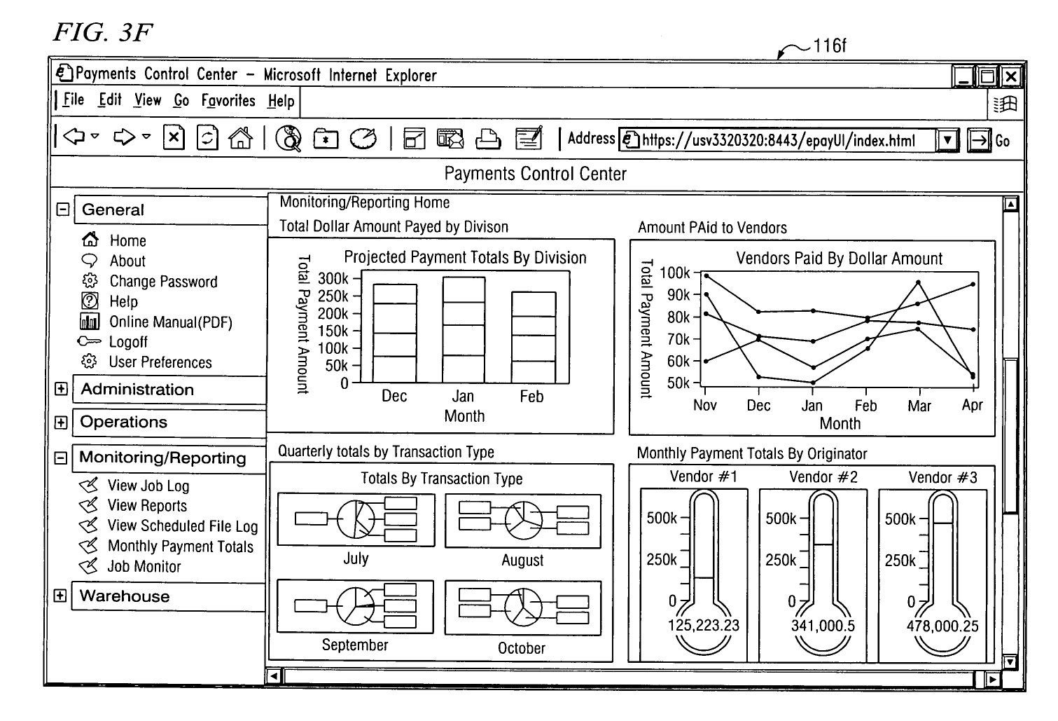

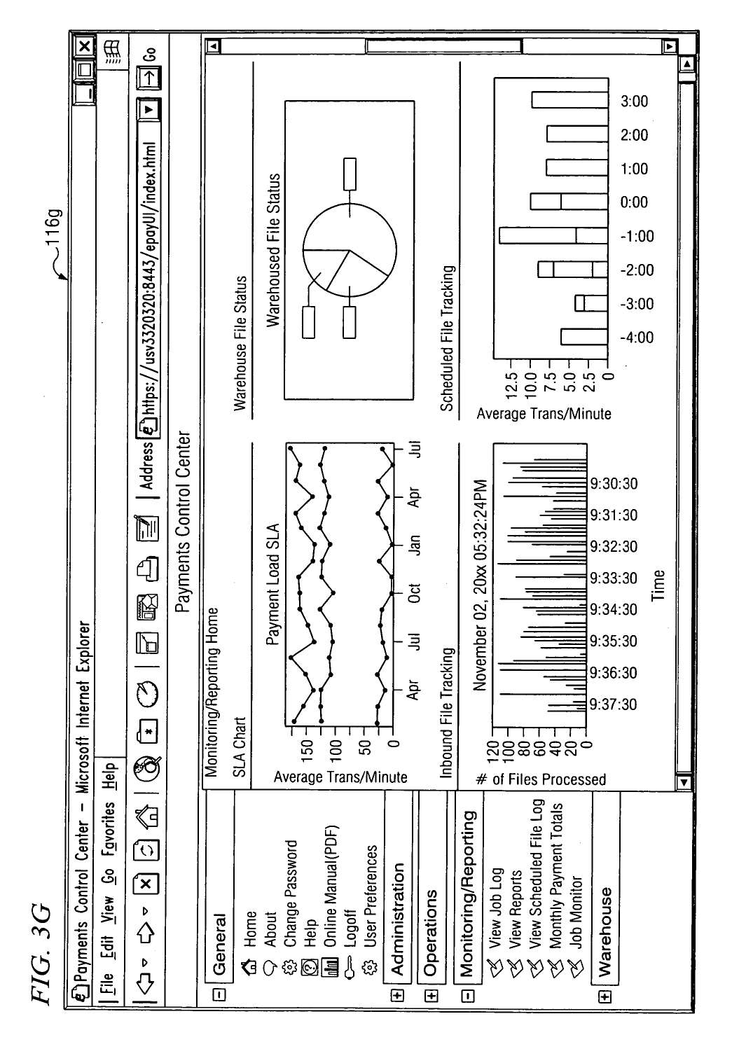

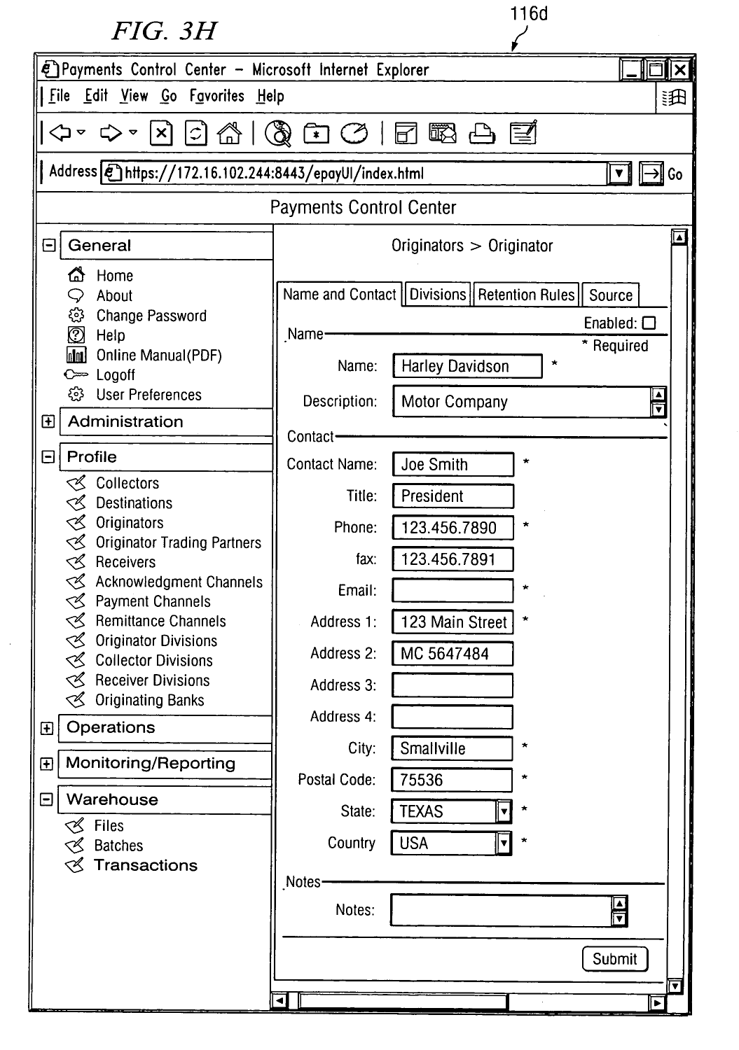

FIGS. 3A-H illustrates various dashboard views 116a-h of payments file metrics and individual payment information. It will be understood that illustrated web pages, 116a-116h respectively, are for example purposes only. Accordingly, GUI 116 may include or present data, such as payment information or metrics, in any format or descriptive language and each page may present any appropriate data in any layout without departing from the scope of the disclosure. Upon login, the authenticated user may be presented with the dashboard (or payments gateway) home page. In certain embodiments, this home page may be customizable per user or based on an associated policy. Upon request of the user (or automatically in certain profiles), dashboard view 116b illustrates one presentation of metrics involving incoming and outgoing X9.37 files. Dashboard views 116c and 116d provide the authenticated used with a view into archive 115, as well as a querying ability. In these example presentations, the user may drill down to dashboard view 116d, which presents individual payment information, from view 116c. Indeed, dashboard view 116e provides even more detailed drill down information on the payment files. Dashboard views 116f and 116g present various management or administration information. For example, these views provide a breakdown of payments by division for management and conformance with expected service level agreements for administration. Such information is often presented in easy-to-read graphs, charts, and such, while also supporting text views. As with the others, these views may be customized as desired. Example dashboard view 116h allows the authenticated user to generate, modify, or delete profiles. In this case, the profile is detailing an originating entity 104.

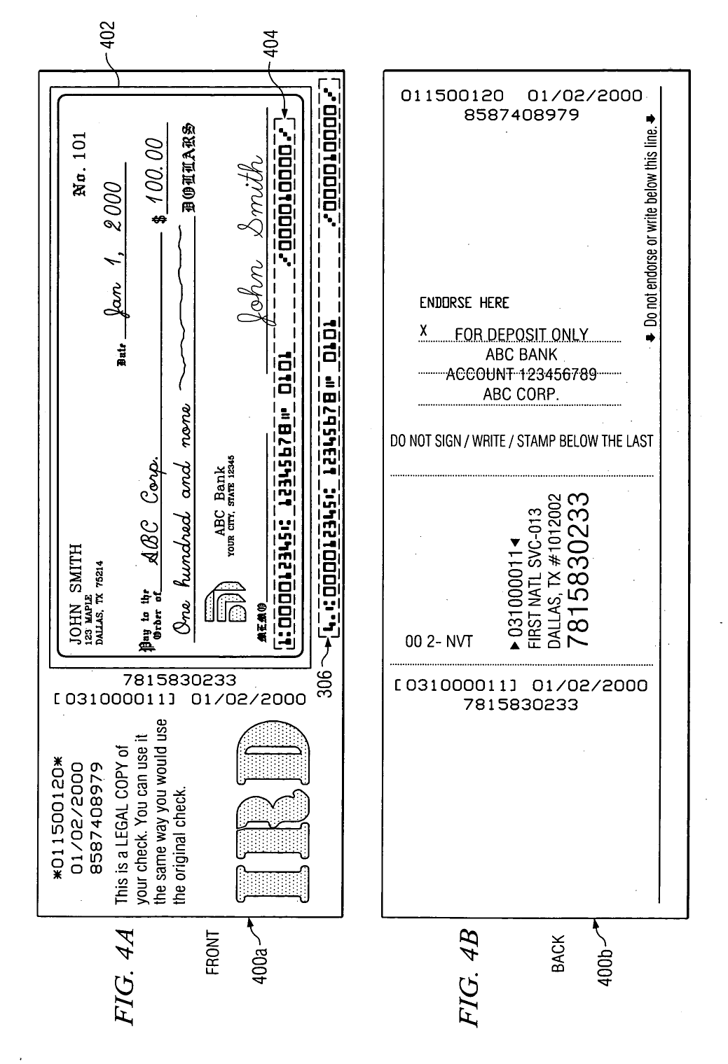

FIGS. 4A-B illustrate one embodiment of an image replacement document (IRD) 400 based on an example electronic check image 114. At a high level, FIG. 4A illustrates the front image 400a of a check 402, while FIG. 4B illustrates the back image 400b of check 402 used by the system of FIG. 1. In this embodiment, check 402 is illustrated as a portion of IRD 400, which may be considered a legal representation of transaction 402. Transaction 402 is associated with two MICR codes 404 and 406, each generated or captured at different points during transaction processing. For example, MICR code 404 may be preprinted on the check prior to the actual transaction. In this example, MICR code 404 includes an item type indicator of “1,” a routing number or field 5 of “12345,” an account number of “12345678,” and a check number of “101.” In this example, MICR code 404 has been supplemented with the captured amount, “100.00,” perhaps at the corporate entity 104 or the financial institution 102 of first deposit. MICR code 406 is substantially similar to MICR code 404, with the difference involving the item type indicator. In MICR code 404, the item type indicator is “1”, while MICR code 406 includes an item type indicator of “4.” FIG. 4B illustrates a back portion of IRD 400. This portion of IRD 400 includes various processing, authorization, and deposit data. For example, the back of the check includes the financial institution 102 of first deposit, namely “First National Bank.” The back of the check further describes the date of first deposit, item sequence number, and any endorsement, in this case a stamp of “For Deposit Only.”

FIGS. 5A-B(1-2) are flowcharts illustrating example methods, 500 and 520 respectively, for processing payments at a payments gateway 130 associated with a financial institution 102 in accordance with certain embodiments of the present disclosure. At a high level, method 500 describes receiving electronic payments through payments gateway 130, as well as the associated gateway processing, and method 520 describes example payment processing of the received payments. The following description focuses on the operation of a particular payments gateway 130 in performing this method. But system 100 contemplates using any appropriate combination and arrangement of logical elements implementing some or all of the described functionality.

Method 500 begins at step 502, where payments gateway 130 receives one or more policies from first corporate entity 104a (or originating entity). For example, an administrator at first corporate entity 104a may remotely access payments gateway 130 and generate or modify the appropriate policies using GUI 116 (such as through view 116h). In another example, first corporate entity 104a transmits a policy (based on a template) for use at the remote payments gateway 130. Next, at step 504, payments gateway 130 implements the policies associated with first corporate entity 104a. For example, payments gateway 130 may invoke portions of the received policies and store the remaining portion of such policies in policies table 140 until subsequently needed once a payments file is received. Next, at step 506, payments gateway 130 identifies characteristics or other metrics of expected payments files based on the invoked policy or portion thereof. These runtime metrics may include an expected time of receipt and such. In other words, payments gateway 130 may load a portion of the received policy (or policies), thereby allowing it to determine when expected files are not received within a certain threshold. Once the policy has been stored or invoked (or both as appropriate), then payments gateway 130 determines if it has received an expected payments file within the appropriate timeframe threshold referenced in the policy as in decisional step 508. This timeframe may be by day, by time, or others. If no payments file has been received within the appropriate timeframe threshold, then payments gateway 130 may automatically communicate an alert message to first corporate entity 140a at step 510. The alert message may be an email message, a Short Messaging Service (SMS) message, a fax message, an automated phone message, an EDI formatted message, or any other policy-based messaging format.

Once a payments file is received, as illustrated at decisional step 511, then payments gateway 130 identifies the characteristics or other metrics of the received payments file at step 512. For example, as illustrated at decisional step 514, payments gateway 130 may determine if the total dollar amount of the payments file is within the associated threshold of the policy. In another example, payments gateway 130 may determine if the number of items included in the payments file are within the associated threshold referenced in the appropriate policy as shown in decisional step 516. Of course, these thresholds are for example purposes only and payments gateway 130 may implement just one or both thresholds in addition to many others. If either of these example thresholds are violated, then payments gateway 130 may communicate an alert message to first corporate entity 104a at step 518. Next, payments gateway 130 processes the payments file at step 520, which is described in more detail in example FIG. 5B. This payments file typically includes a plurality of payment records, each associated with a receiving entity (such as second corporate entity 104b. For example, first corporate entity 104a may pay two vendors or two receiving entities in one batch (or file) via electronic payments. At step 522, payments gateway 130 generates an automatic notification message to first corporate entity 104a. In one embodiment, this notification message may inform management, an administrator, or other back-office employee that the payments file has been received by financial institution 102a and has been suitably processed or deposited. In other embodiments, this notification message may include or link to one or more HTML or PDF reports such as, for example, management reports, code distribution reports, profile distribution reports, profile change reports, audit log, error reports, historical reporting, reports of user activity, and reports of security violations. Next, payments gateway 130 may generate a web page associated with the received payments file at step 524 for use by receiving entities (such as second corporate entity 104b) indicated by the invoked policies. Returning to the example, first corporate entity 104a may allow for one vendor to view expected payments, while barring the other vendor, for any particular business reason. This web page may include information for each of the payment records or items associated with the accessing receiving entity. Such information may be represented by hyperlinks (or similar technology) that allow an authorized user from the second corporate entity 104b to drill down on individual items to verify or identify associated information such as invoices, purchase items, and others. This drill down capacity might allow first corporate entity 104a to reduce its back office or call center staff and save costs, while allowing the payees to quickly view incoming payments and the associated payment information. Next, payments gateway 130 generates or updates the metrics web page based on the identified characteristics or metrics of the received payments file at step 526. For example, payments gateway 130 may list the various metrics identified from the payments file based on the implemented or invoked policy. These metrics may be in different colors, font, or in another distinguishing format operable to allow the accessing user to differentiate between metrics that did or did not violate its associated threshold. If the implemented policy allows for adaptive thresholds at decisional step 528, then payments gateway 130 dynamically modifies the one or more adaptive thresholds using the metrics from the received payments file at step 530.

Method 520 begins at step 550, where payments gateway 130 (or another associated module) performs duplicate processing on the received payments file. For example, payments gateway 130 may ensure (or attempt to ensure) that the received payments file is not a duplicate of another received file, that individual items are not duplicates, or any other appropriate duplicate processing. In certain embodiments, if the duplicate processing results in an error at decisional step 552, then processing may end. In alternative embodiments, payments gateway 130 may automatically report duplicate cash letters, report duplicate bundle detection, hold the file containing abeyance, release held file, and/or filter duplicates based on instructions in the policy. If it is to continue processing the file, payments gateway 130 parses the payments file into individual payment records or items at step 554. Next, payments gateway 130 may then sort the payment records by receiving corporate entity 104b at step 556. Payments gateway 130 identifies the first payment record in the sorted payments file at step 558. At step 560, payments gateway 130 identifies the receiving corporate entity 104 of the first identified payment record. Payments gateway 130 then adds the payment record to temporary storage, such as memory 120 or other suitable data structure, at step 562. Next, at decisional step 563, payments gateway 130 determines if there are more records in the sorted payments file. If there are, then payments gateway 130 identifies the next payment record in the sorted payments file and identifies receiving corporation of the particular payment record at step 566. Payments gateway 130 then determines if the current receiving entity 104 is the same as that of the prior record at decisional step 568. If it is, then payments gateway 130 adds the current record to temporary storage at step 562 and processing proceeds to decisional step 563 as before.

But if the current receiving entity 104 is different from that of the prior record or if there are no more records, then payments gateway 130 determines if the prior receiving entity 104 is referenced in the originating entity's invoked policy at decisional step 570. If the policy authorizes such actions, then payments gateway 130 generates a notification message based on the payment records stored in memory 120 at step 572. This notification message may then be communicated, via any appropriate transmission or in any suitable format, to the prior receiving entity 104 at step 574. Next, payments gateway 130 determines if the prior receiving entity 104 is associated with an ERP module (or other ERP-like system) based on the appropriate policy at decisional step 576. If so, then payments gateway 130 generates a consolidated ERP receivables file at step 578, based on the payment records and the associated information in memory 120. This consolidated ERP receivables file is then communicated to the prior receiving entity 104 at step 580, thereby allowing the receiving entity to interface or otherwise load the receivables file directly into its ERP system. Next, payments gateway 130 determines if the first corporate entity 104 is associated with policies that authorize least cost routing at decisional step 582. If so, then payments gateway 130 invokes the appropriate least cost routing process at step 584. Otherwise, first financial institution 102a communicates a file to the next financial institution 102b for presentation of the electronic payments using any standard processing for other entities 104, as shown in step 586.

FIG. 6 is a flowchart illustrating an example method 600 for processing payments at a payments gateway 130 associated with a corporate entity 104 (such a corporate headquarters) in accordance with certain embodiments of the present disclosure. As with FIGS. 5A-B, the following description focuses on the operation of a particular payments gateway 130 in performing these methods. But system 100 contemplates using any appropriate combination and arrangement of logical elements implementing some or all of the described functionality. Indeed, while described as at least partially occurring at the processing center of financial institution 102, method 600 may be performed at any appropriate banking location such as, for example, at a branch or data processing center associated with financial institution 102.

Example method 600 begins at step 602 when payments gateway 130 receives bundled electronic or physical payments for paying other receiving entities 104b. In certain embodiments, payments gateway 130 may generate electronic payments using any received physical checks and consolidate the various electronic payments into one payments file. Payments gateway 130 then invokes a particular policy associated with the first store from policy table 140 at step 604. Payments gateway 130 compares the received file with the invoked policy at step 606 to determine if some or all of the payments file is within expected tolerances. For example, the invoked policy may include a plurality of thresholds identifying an expected range of metrics associated with files from the first store. As illustrated at decisional step 608, if the metrics are not within the particular thresholds, then payments gateway 130 may communicate an alert message to the appropriate administrator at step 610. The alert message may be an e-mail, an SMS message, or another communication in a suitable policy-based messaging format. Moreover, the alert message may include all of the various metrics including those that did not violate the identified thresholds. In certain embodiments, payments gateway 130 may automatically adapt or modify the thresholds based on the metrics of the received payments files. For example, payments gateway 130 identifies particular patterns of volume, receipt time, or dollar amounts and modify such thresholds to accommodate the identified patterns.

Once payments gateway 130 has processed the overall file metadata, then it may store the payments file in temporary storage such as memory 120 at step 612. Next, payments gateway 130 determines if the invoked policy allows least cost routing at decisional step 614. If it does, and payments gateway 130 invokes the appropriate least cost routing process based on the invoked policy at step 616. Then, for example, payments gateway 130 may process individual payment records within the received payments file according to certain business rules and attempt to reduce costs for the particular store in accordance with the entity's policy. Payments gateway 130 then identifies a channel for communication of the payments to financial institution 102 for deposit. As described above, the channel may be associated with the number of properties including the channel format, destination IP address, destination directory, and others. At decisional step 620, payments gateway 130 determines if the channel format is different from the current format of the received payments file. If it is, then payments gateway 130 may convert the payments file to the format associated with the channel at step 622. For example, payments gateway 130 may determine that the identified channel is associated with ACH payment records, if the current format of the payments file is X9.37. At step 622, payments gateway 130 converts the payments file to the format associated with the channel. In certain embodiments, payments gateway 130 may augment the data to ensure compatibility or conformance with the desired standard or proprietary format. At step 624, payments gateway 130 communicates the converted payments file to the appropriate destination, such as first financial institution 102, via the identified channel.

The preceding flowcharts and accompanying descriptions illustrate exemplary methods 500, 520, and 600. But system 100 contemplates using any suitable technique for performing these and other tasks. Accordingly, many of the steps in these flowcharts may take place simultaneously and/or in different orders than as shown. Moreover, system 100 may use methods with additional steps, fewer steps, and/or different steps, so long as the methods remain appropriate. For example, it will be understood that payments gateway may perform some or all of the processing described by method 500, while processing payments in a process different from method 520. In another example, payments gateway 130 may comprise a distributed application that executes processes implementing techniques similar to all of methods 500, 520, and 600.

Although this disclosure has been described in terms of certain embodiments and generally associated methods, alterations, and permutations of these embodiments and methods will be apparent to those skilled in the art. For example, corporate entity 104 may process electronic checks, as well as physical checks and other payment types. In another example, the payments gateway may be installed at or executed by one of the paying entities, one of the financial institutions, or both. Accordingly, the above description of example embodiments does not define or constrain this disclosure. Other changes, substitutions, and alterations are also possible without departing from the scope of this disclosure.

What is claimed is:

1. A payments gateway operable to:
receive a payments file from an originating entity;
invoke a policy associated with the originating entity, the policy comprising references to at least a subset of a plurality of receiving entities;
parse the payments file into a plurality of payment records, each record associated with a particular one of the plurality of receiving entities;
identify a first receiving entity associated with one of the payment records and referenced in the policy; and
automatically provide a dashboard view to the identified receiving entity, the dashboard view presenting information on the one or more associated payment records.

2. The payments gateway of claim 1, further operable to automatically provide a second dashboard view to the originating entity, the second dashboard view presenting a plurality of metrics associated with the received payments file.

3. The payments gateway of claim 2, the invoked policy further comprising references to a plurality of thresholds and the payments gateway further operable to:
determine the metrics of the payments file upon receipt; and
compare a first of the determined metrics to an associated first of the referenced thresholds.

4. The payments gateway of claim 3, further operable to modify one of the referenced thresholds based on an associated one of the determined metrics.

5. The payments gateway of claim 3, further operable communicate an alert message to the originating entity when one of the metrics is outside the associated threshold.

6. The payments gateway of claim 3, further operable communicate an alert message to one of the receiving entities when one of the metrics is outside the associated threshold.

7. The payments gateway of claim 6, the alert message comprising one of an email message, a Short Messaging Service (SMS) message, a fax message, an automated phone message, or an EDI formatted message.

8. The payments gateway of claim 3, the metrics comprising:
general item volume metric;
general receipt time of payments file metric;
geographical-based metric;
channel-based metric;
high dollar item metric;
high dollar deposit by receiving entity;
high dollar deposit by channel;
transmission failure metric;
transmission speed metric; and
one of a plurality of service level agreement parameters.

9. The payments gateway of claim 2, the originating entity comprising one of a plurality of related stores.

10. The payments gateway of claim 9, the second dashboard view secured from access by the remaining related stores.

11. The payments gateway of claim 9, the payments gateway comprising a first payments gateway, associated with a corporate headquarters, and communicably coupled with a second payments gateway associated with a financial institution.

12. The payments gateway of claim 1, the payments file in a first of a plurality of formats and the payments gateway further operable to:
identify a first of a plurality of channels associated with the payments file based on the first receiving entity;
generate a second payments file in a second of the plurality of formats including at least a subset of the payments records, the second format determined based on the identified first channel; and
communicate the second payments file to a financial institution for deposit in an account associated with the first receiving entity.

13. The payments gateway of claim 12, further operable to:
invoke a second policy associated with the first receiving entity;
identify the first channel using the invoked second policy; and
execute a least cost routing process for the second payments file based on the invoked policy.

14. The payments gateway of claim 13, the payments file in a first of a plurality of formats and the payments gateway and wherein the payments gateway operable to execute the least cost routing process based on the invoked policy comprises the payments gateway operable to invoke a plurality of business rules associated with the first receiving entity and wherein the payments gateway operable to generate the second payments file in the second of the plurality of formats including at least a subset of the payments records comprises the payments gateway operable to:
generate a third payments file in the second format based on the invoked business rules, the third payments file including a portion of the subset of payment records; and
generate a fourth payments file in a third of the plurality of formats based on the invoked business rules, the fourth payments file including a second portion of the subset of payment records.

15. The payments gateway of claim 12, further
operable to:
invoke a second policy associated with the first receiving entity;
identify an Enterprise Resource Planning (ERP) module associated with the first receiving entity based on the invoked policy;
generate an ERP receivables file based on the second payments file and the identified ERP module, the ERP receivables file compatible with the ERP module; and
communicate the ERP receivables file to the receiving entity.

16. The payments gateway of claim 1, the dashboard view presenting the payments records associated with the first receiving entity and allowing the first receiving entity to drill down on each presented payment record.

17. The payments gateway of claim 16, each presented payments record associated with the following drill down information:
scheduled time of payment;
actual time of payment;
amount of payment;
invoice number; and
items included in invoice.

18. The payments gateway of claim 1, further operable to perform duplicate processing on the received payments file.

19. The payments gateway of claim 1, further operable to:
monitor access of the dashboard view by the first receiving entity;
automatically generate a bill for the monitored access; and
communicate the bill to the first receiving entity via a network connection.

20. The payments gateway of claim 1, the payments file in one of a plurality of formats comprising:
X9.37;
ACH;
X12;
flat file;
XML;
SWIFT;
EDI FACT;
a propriety format;
ACH-CCD; and
ACH-CTX.

21. The payments gateway of claim 1, each payment record comprising an electronic check image generated from a paper check at the originating entity, each electronic check image operable to generate an image replacement document (IRD).

22. A method for centralized processing of electronic payments comprising:
receiving a payments file from an originating entity at a payments gateway;
invoking a policy associated with the originating entity, the policy comprising references to at least a subset of a plurality of receiving entities;
parsing the payments file into a plurality of payment records, each record associated with a particular one of the plurality of receiving entities;
identifying a first receiving entity associated with one of the payment records and referenced in the policy; and
automatically providing a dashboard view to the identified receiving entity, the dashboard view presenting information on the one or more associated payment records.

23. The method of claim 22, further comprising automatically providing a second dashboard view to the originating entity, the second dashboard view presenting a plurality of metrics associated with the received payments file.

24. The method of claim 23, wherein the invoked policy comprises references to a plurality of thresholds and the method further comprising:
determining the metrics of the payments file upon receipt; and
comparing a first of the determined metrics to an associated first of the referenced thresholds.

25. The method of claim 24, further comprising modifying one of the referenced thresholds based on an associated one of the determined metrics.

26. The method of claim 24, further comprising communicating an alert message to the originating entity when one of the metrics is outside the associated threshold.

27. The method of claim 25, further comprising communicating an alert message to one of the receiving entities when one of the metrics is outside the associated threshold.

28. The method of claim 26, the alert message comprising one of an email message, a Short Messaging Service (SMS) message, a fax message, an automated phone message, or an EDI formatted message.

29. The method of claim 24, wherein the metrics comprise:
general item volume metric;
general receipt time of payments file metric;
geographical-based metric;
channel-based metric;
high dollar item metric;
high dollar deposit by receiving entity;
high dollar deposit by channel;
transmission failure metric;
transmission speed metric; and
one of a plurality of service level agreement parameters.

30. The method of claim 23, the originating entity comprising one of a plurality of related stores.

31. The method of claim 30, the second dashboard view secured from access by the remaining related stores.

32. The method of claim 30, the payments gateway comprising a first payments gateway, associated with a corporate headquarters, and communicably coupled with a second payments gateway associated with a financial institution.

33. The method of claim 22, the payments file in a first of a plurality of formats and the method further comprising:
identifying a first of a plurality of channels associated with the payments file based on the first receiving entity;
generating a second payments file in a second of the plurality of formats including at least a subset of the payments records, the second format determined based on the identified first channel; and
communicating the second payments file to a financial institution for deposit in an account associated with the first receiving entity.

34. The method of claim 22, the payments file in a first of a plurality of formats and the method further comprising:
invoking a second policy associated with the first receiving entity;
identifying the first channel using the invoked second policy; and
executing a least cost routing process for the second payments file based on the invoked policy.

35. The method of claim 34, wherein executing the least cost routing process based on the invoked policy comprises invoking a plurality of business rules associated with the first receiving entity and wherein generating the second payments file in the second of the plurality of formats including at least a subset of the payments records comprises:
generating a third payments file in the second format based on the invoked business rules, the third payments file including a portion of the subset of payment records; and
generating a fourth payments file in a third of the plurality of formats based on the invoked business rules, the fourth payments file including a second portion of the subset of payment records.

36. The method of claim 22, further comprising:
invoking a second policy associated with the first receiving entity;
identifying an Enterprise Resource Planning (ERP) module associated with the first receiving entity based on the invoked policy;
generating an ERP receivables file based on the payments file and the identified ERP module, the ERP receivables file compatible with the ERP module; and
communicating the ERP receivables file to the receiving entity.

37. The method of claim 22, the dashboard view presenting the payments records associated with the first receiving entity and allowing the first receiving entity to drill down on each presented payment record.

38. The method of claim 37, wherein each presented payments record associated with the following drill down information comprises:
scheduled time of payment;
actual time of payment;
amount of payment;
invoice number; and
items included in invoice.

39. The method of claim 22, further comprising performing duplicate processing on the received payments file.

40. The method of claim 22, further comprising:
monitoring access of the dashboard view by the first receiving entity;
automatically generating a bill for the monitored access; and
communicating the bill to the first receiving entity via a network connection.

41. The method of claim 22, the payments file in one of a plurality of formats comprising:
X9.37;
ACH;
X12;
flat file;
XML;
SWIFT;
EDIFACT;
a propriety format;
ACH-CCD; and
ACH-CTX.

42. The method of claim 22, each payment record comprising an electronic check image generated from a paper check at the originating entity and the method further comprising generating an image replacement document (IRD) based on one of the electronic check images.

43. The method of claim 22, wherein receiving the payments file from the originating entity at the payments gateway comprises:
receiving a plurality of physical checks from the originating entity;
generating an electronic payment for each of the physical checks; and
loading the electronic payments at the payments gateway.

44. A method for processing electronic payments at a corporate headquarters, comprising:
receiving a payments file from a store associated with the corporate headquarters, the payments file including a plurality of electronic payments to at least one receiving entity;
generating a first dashboard view for the store, the dashboard view presenting a plurality of transmission metrics;
generating a second dashboard view for a first of the one or more receiving entities, the second dashboard view providing a plurality of electronic payment information and operable to allow drill downs on the information;
generating an Enterprise Resource Planning (ERP) receivables file based on the payments file and the first receiving entity;
communicating the ERP receivables file to the first receiving entity; and
communicating the payments file to a financial institution for payment processing.
